(19) United States
(12) Patent Application Publication
(10) Pub. No.: US 2015/0292474 A1
(43) Pub. Date: Oct. 15, 2015

(54) DEVICE FOR UTILISATION OF KINETIC ENERGY OF A FLOWING MEDIUM

(71) Applicant: ATLANTISSTROM GMBH & CO. KG, Tangstedt (DE)

(72) Inventor: Kai-Ude JANSSEN, Wolfsburg (DE)

(73) Assignee: Atlantisstrom GmbH & Co. KG, Tangstedt (DE)

(21) Appl. No.: 14/440,799

(22) PCT Filed: Nov. 4, 2013
(86) PCT No.: PCT/EP2013/003302

§ 371 Date: May 5, 2015

(30) Foreign Application Priority Data
Nov. 7, 2012 (DE) 10 2012 021 674.2

(51) Int. Cl. F03B 13/26; F03B 17/06

(52) U.S. Cl. CPC F03B 13/264; F03B 17/065

(57) ABSTRACT

The invention relates to a device for utilisation of kinetic energy of a flowing medium comprising support members (2) mounted on a shaft (16) about an axis of rotation (6) and axially spaced apart from one another, and between which pressure surfaces (3) are disposed which are mounted pivotably about an axis (4) on the support members (2) and are supported on stops (5) which limit the pivoting movement, wherein a flow guiding means (7) designed as a buoyancy member is radially spaced from the pressure surfaces (3) and together with the pressure surfaces (3) forms a contour which narrows the flow cross-section between the pressure surfaces (3) and the flow guiding means (7).

The invention relates to a device for utilizing kinetic energy of a flowing medium, with support members which are mounted on a shaft about an axis of rotation and are spaced apart axially from each other, and between which there are arranged pressure surfaces that are mounted on the support members so as to be able to pivot about an axis and that bear against stops which limit the pivoting movement. The device is particularly suited to use as a tidal power plant in which alternating flow directions are present.

It is known to use such devices in bodies of water in order to convert the energy of the moving water, that is to say a flow, into electrical current. These flows are a result of, for example, the tides, that is to say the outgoing and incoming tide, or flows as may also be encountered in rivers.

DE 24 34 937 discloses an underwater electricity generator which has a turbine with rotatable pressure surfaces that bear against a stop and can thus generate rotation from the flow of the water. When these pressure surfaces do not bear against the stops, they orient themselves with the flow of the water and thus present less resistance to the latter. Furthermore, there is described an adjustable deflection plate which is arranged upstream of the turbine and deflects the water current such that this current is directed to that side on which the pressure surfaces are against the stop.

GB 2 190 144 A relates to a water wheel device with a rotatable, horizontally oriented drum which is anchored to the sea floor. It is possible for a deflection plate to be arranged upstream of the drum in order to apply the greatest possible water force to the pressure surfaces.

The known devices are complex and their application in tidal power plants is limited. The present invention has the object of providing a device which is versatile in its application, converts the flow energy efficiently and is cost-effective to produce.

This object is achieved according to the invention with a device having the features of the principal claim; advantageous embodiments and developments of the invention are disclosed in the subclaims, the description and the figures.

The device according to the invention for utilizing kinetic energy of a flowing medium, with support members which are mounted on a shaft about an axis of rotation and are spaced apart axially from each other, and between which there are arranged pressure surfaces that are mounted on the support members so as to be able to pivot about an axis and that bear against stops which limit the pivoting movement, provides that, spaced radially from the pressure surfaces, there is arranged a flow guiding device which is designed as a buoyancy member and forms, together with the pressure surfaces, a contour that narrows the flow cross section between the pressure surfaces and the flow guiding device. The invention makes use of part of the necessary frame to achieve a better flow situation for the pressure surfaces. By virtue of the flow guiding device which extends above the space between the support members, is spaced radially from the pressure surfaces, is designed as a buoyancy member and forms, together with the pressure surfaces, a contour that narrows the flow cross section between the pressure surfaces and the flow guiding device, the flow speed of the water is increased. The flow guiding device is designed as a buoyancy member such that it is always above the axis of rotation during operation in water. By virtue of the relatively large distance between the center of buoyancy and the center of gravity, it is possible to achieve high stability for the device immersed in the flow. According to the invention, the orientation of the flow guiding device is used to direct the water into a region in which the pressure surfaces bear against their stops and thus transmit the power of the flow into the rotation. The buoyancy can be generated by using materials or combinations of materials whose density is lower than that of the surrounding medium, or by means of hollow bodies filled with air or other gases.

As a preferred embodiment, the buoyancy member can be curved in the direction of the axis of rotation. As a consequence of this curvature, the flow speed on the side of the pressure surfaces can be increased through the Bernoulli effect.

The flow guiding device can extend above both support members and project beyond them, such that the flow guiding device and the buoyancy member is longer than the separation between the two support members. As a consequence, the flow can be influenced in a larger region and even out the flow conditions in the region of the pressure surfaces, since the flow speed is increased also at the edge regions and at the outer sides of the support bodies.

The flow guiding device can further be symmetric in cross section. This is particularly advantageous when using tides, since when making use of tidal flows the flow direction reverses periodically. By virtue of the symmetric shape of this flow guiding device, the effect achieved thereby can be used in both flow directions, without it being necessary to adjust components on the device.

Arms, on which the shaft is mounted, can project from the flow guiding device. In this manner, the flow guiding device can rotate freely with respect to the shaft. These arms can also be designed as walls in order to be able to have an additional influence on the flow in the direction of the pressure surfaces and so as to be able to automatically orient the device in the flow. It is also provided that the walls can be designed as hollow bodies or buoyancy members. It is thus possible to make use of a further buoyancy effect in the walls.

The stops provided for the pressure surfaces can be arranged on the shaft, distributed over the length of the latter, in order to achieve even loading on the rims of the pressure surfaces. As a consequence, the pressure surfaces can be made lighter and less stable without durability being reduced. In addition, in the case of an almost complete installation, the pressure surfaces deform negligibly over their length, such that the construction is made more stable and the efficiency is increased.

Moreover, the stops can be attached to the shaft on projecting supports and, where relevant, have a damping device or be made of a damping material. The advantage of these embodiments is that, when the pressure surfaces tip over, the force is spread over the entire width of the shaft and the impulse when the bearing pressure surfaces come to bear is damped, and thus, even in the case of strong currents, the risk of damage is minimized. Furthermore, configuring the stops with dampers or as dampers reduces sound emissions, such that noise-sensitive organisms in their environment are less affected.

It is moreover possible, on the device according to the invention, for a generator to be connected to the drive shaft, either directly or via a transmission.

A development of the invention provides that the shaft, the stops, the arms and/or support bodies have a curvature which is oriented toward the pressure surfaces. The respective curvature toward the pressure surfaces results in a contour which guides the flow in such a manner that the flow cross section is reduced in the direction of the pressure surfaces bearing against the stops, such that it is possible to achieve an increase in the incident flow speed or the incident flow pressure. In that context, the shaft or the stops have a barrel-shaped contour, the support bodies have a conical, domed or rounded shape and the arms have a contour which tapers in the direction of the mounting points of the shaft.

The invention will be explained in more detail with respect to exemplary embodiments represented in the figures. Identical reference signs in the figures denote identical components. In the figures:

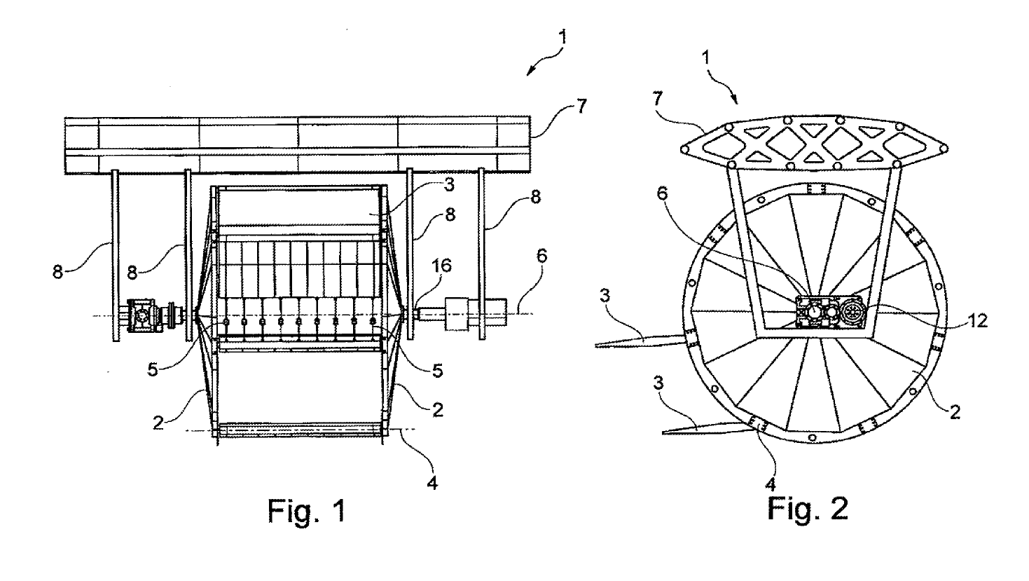

FIG. 1 is a plan view of a device;

FIG. 2 is a side view of the device of FIG. 1;

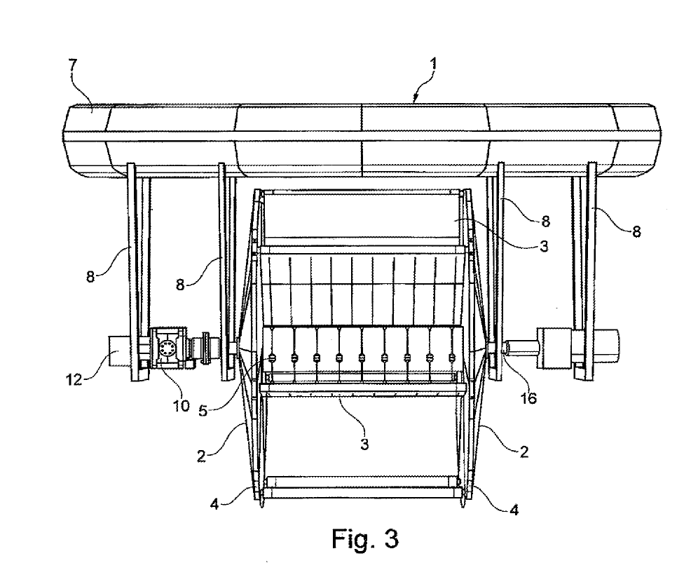

FIG. 3 is a perspective view of the device of FIG. 1;

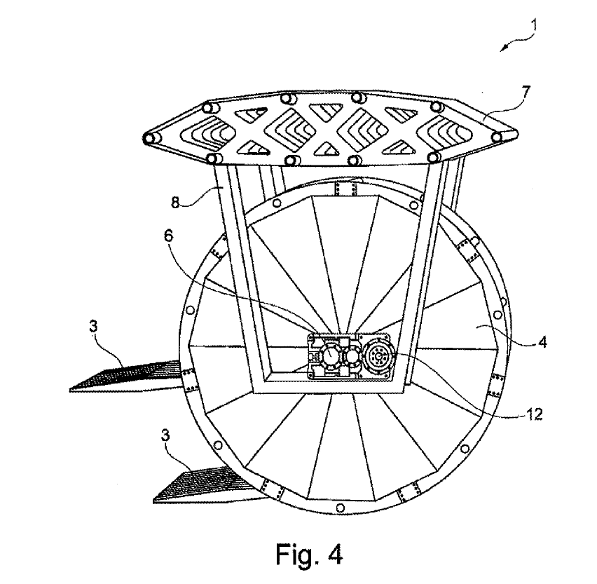

FIG. 4 is a perspective view of FIG. 2;

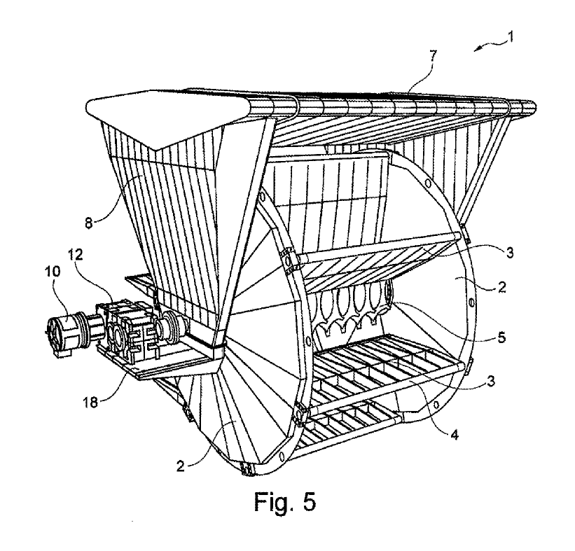

FIG. 5 is a perspective view of a variant of the device;

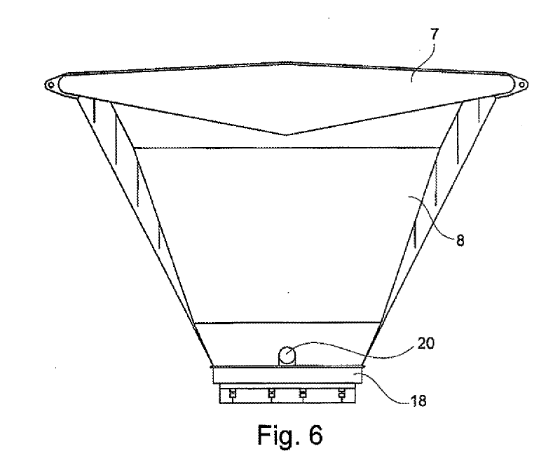

FIG. 6 is a sectional side view of a buoyancy member according to FIG. 5;

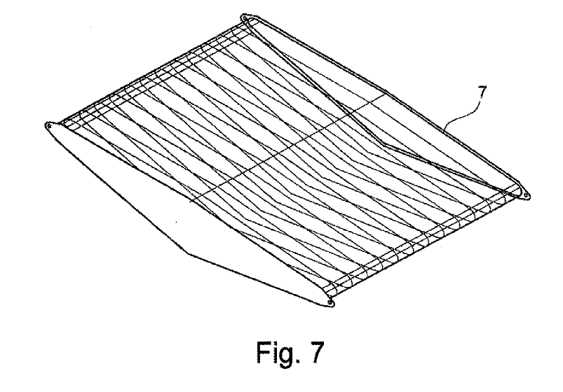

FIG. 7 is a representation of a flow guiding device in isolation;

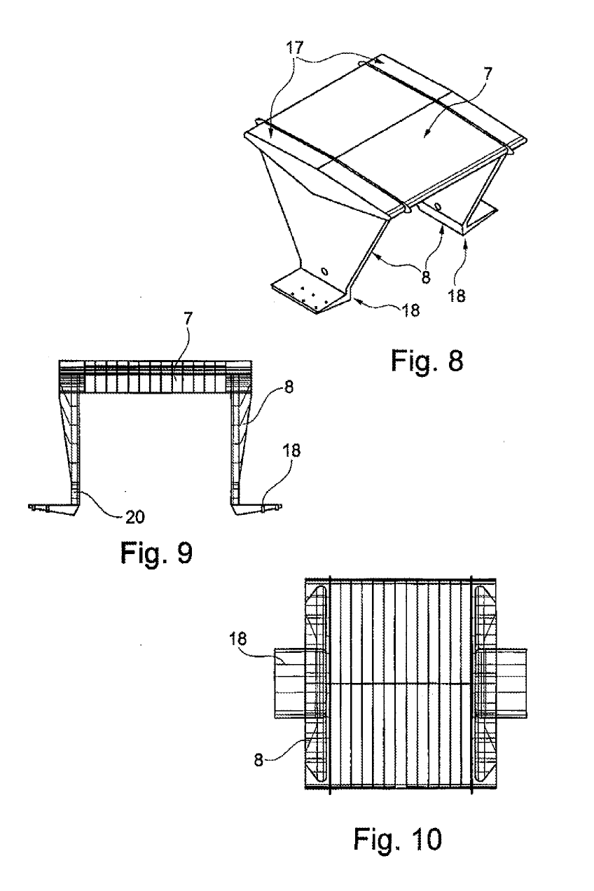

FIG. 8 is a perspective overall view of the flow guiding device;

FIG. 9 is a front view of FIG. 8;

FIG. 10 is a plan view of FIG. 8;

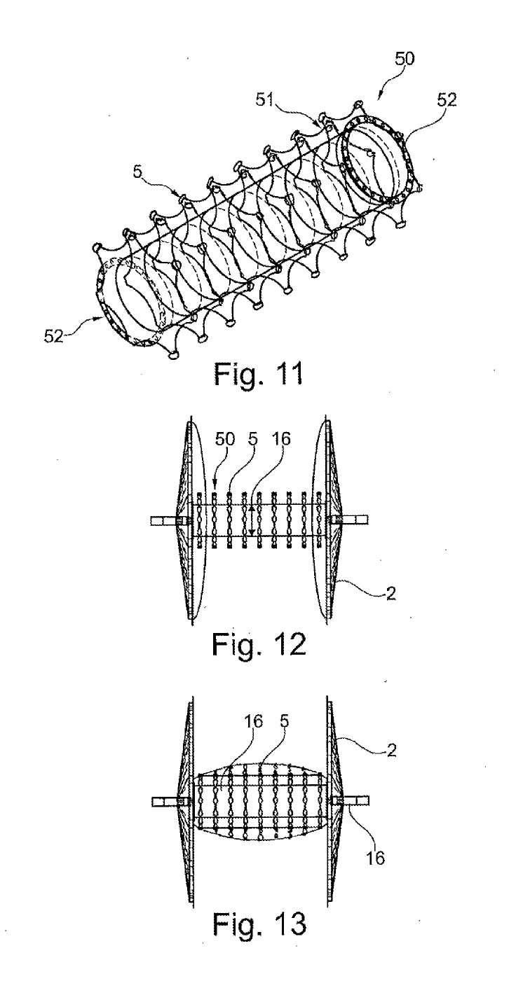

FIG. 11 is a representation of a stop sleeve in isolation;

FIG. 12 shows a variant of the support members on the shaft and

FIG. 13 shows a variant of the shaft and stops.

FIG. 1 shows a front view of a device 1 for utilizing kinetic energy of a flowing medium, in particular water. The device 1 provides for two support members 2, in the form of support disks, which, spaced apart from each other, are connected to a shaft 16 in a rotationally fixed manner and such that they can rotate about an axis of rotation 6. The shaft 16 is mounted on, in total, four arms 8 which extend radially with respect to the shaft 16. The arms 18 are connected via a flow guiding device 7 which is arranged radially outside the support bodies 2. The flow guiding device 7 forms, together with the arms 8, a bridge-like frame in which both the shaft 16 and the two support members 2 are mounted rotatably.

Pressure surfaces 3 are arranged between the two support members 2 and evenly around the circumference of the support members 2. The pressure surfaces 3 are mounted such that they can pivot about axes 4 and bear, with that edge which is designed to be remote from the axis of rotation 4, against stops 5 which are arranged on the shaft 16.

In FIG. 1, the device 1 is shown in the operating state, in which the device 1 is arranged immersed in a flow, for example in a river channel or in a tidal flow. In that context, both the axis of rotation 6 and the longitudinal extent of the flow guiding device 7 are oriented essentially horizontally, the axes 4 of the pressure surfaces 3 are oriented parallel to the axis of rotation 6. The stops 5 are arranged evenly over the entire interspace between the support members and can be designed as projections having damper elements arranged thereon. The design as projections makes it possible for the pressure surfaces 3 to impact on the stops 5 on both sides, such that reverse operation is possible in the case of changing flow direction, without conversion measures. Advantageously, the stops 5 lie on the connection line between the respective axis 4 of the assigned pressure surface 3 and the axis 6.

FIG. 1 shows a flow situation in which the flow is oriented perpendicular to the airfoil plane into the airfoil plane. Those pressure surfaces 3 which are positioned below the axis of rotation 6 orient themselves essentially horizontally into the flow;

those pressure surfaces 3 which are above the axis of rotation 6 are pressed by the flow against the stops 5 and thus form a resistance surface by means of which the support members 3 and thus the shaft 16 are driven in rotation.

The flow guiding device 7 above the support members 2, that is to say spaced apart radially with respect to the support members 2, guides the incident fluid, predominantly water, in the direction of the pressure surfaces 3, which are located in the flow so as to perform work, such that there results an increase in the flow speed on account of a narrowing cross section in the flow direction toward the pressure surfaces 3. It is thus possible to increase the efficiency of the device 1.

FIG. 2 is a sectional side view in which part of the flow guiding device 7 is cut away. The figure shows that the flow guiding device 7 is designed with a plane of symmetry which passes vertically through the axis of rotation 6 and that it is curved toward the support members 2, such that incident water is guided toward the pressure surfaces 3. FIG. 2 shows that the lower pressure surfaces 3 are in an essentially horizontal position in the flow, which in the exemplary embodiment shown is incident from the right. The flow guiding device 7 is curved both toward the axis of rotation 6 and away therefrom, so as to give a symmetric, wing-like or elliptical cross section contour. The flow guiding device 7 can be designed as a hollow body such that, by filling it with a relatively light medium, in particular air, it is possible to change the buoyancy properties of the device 1 which can be anchored such that it is immersed.

Within the arm 8, which is attached in the manner of a U-shaped support to the underside of the flow guiding device 7, there is also arranged, in addition to the mounting for the shaft 16, a transmission 12 for changing, in particular increasing, the rotational speed of the shaft 16.

The side view of FIG. 2 shows that the pressure surfaces 3 are mounted, on one side, on the outer circumference of the support member 2 in an articulated manner such that they can pivot about the axes 4. In the represented exemplary embodiment, the support members 2 are circular and have a disk-like structure such that it is also possible for a cavity to be formed within the support member 2 in order to be able to provide a buoyancy potential. In the operating state, the flow guiding device 7 is always located above the support members 2, such that the minimum separation with respect to the support member 2 is defined by the maximum radius of the support member 2 about the axis of rotation 6. The lower side of the flow guiding device 7, that is to say that side which is oriented toward the axis of rotation 6, is arranged in the represented exemplary embodiment with a small separation with respect to the circumference of the support member 2. The flow guiding device 7 is designed to be stiff and represents a support or a bridge element for mounting the support members 2 with the pressure surfaces 3.

FIG. 3 is a perspective view of the device 1 according to FIG. 1, in which, in addition to the transmission 12, a generator 10 is also attached to the outer arm 8 in order to be able to directly convert the rotational movement of the shaft 16 into electrical energy. FIG. 3 shows the stops 5 with the damper devices and the symmetric configuration, curved in the manner of a wing, of the underside of the flow guiding device 7, in the direction of the pressure surfaces 3.

FIG. 4 is a perspective sectional representation similar to FIG. 2, showing that a multiplicity of supporting elements which are arranged one behind another, that is to say next to one another in the longitudinal extent of the axis of rotation 6. An outer sleeve, which forms a cavity, is fitted onto the outer side of the supporting elements such that the flow guiding device 7 simultaneously serves as a buoyancy member.

FIG. 5 shows a variant of the invention in which the flow guiding device 7 and the arms 8 are designed differently to the embodiment in FIGS. 1 to 4. Moreover, the flow guiding device 7 extends above the entire width of the pressure surfaces 3, at the ends of the flow guiding device 7 there are arranged walls as arms 8, which extend, tapering from the respective leading edges 17, in the direction of the shaft 16. Below the axis of rotation 6 there are arranged or formed brackets 18 which run parallel to the orientation of the axis of rotation 6 and accommodate the transmission 12 and the generator 10 as well as mountings for the shaft 16. The arms 8 are formed as closed walls and may perform a buoyancy function. The flow guiding device 7, which is arranged in the manner of a bridge above the support members 2 and pressure surfaces 3, has an angled contour with the underside of the flow guiding device 7 being of inclined design. The faces of the underside, which are oriented at an angle to one another, meet in the middle of the arms 8; the upper side of the flow guiding device 7 can be curved or have a slightly angled contour.

The unit consisting of the flow guiding device 7 and the arms 8 can be of one-piece design, so as to give a sort of yoke in which the support members 2 and the shaft 16 can be mounted. Designing the flow guiding device 7 as a buoyancy member, whether by designing a cavity within the flow guiding device 7 or by using specifically lightweight materials, increases the separation between the center of buoyancy and the center of gravity of the device 1, resulting in a very stable position of the device 1 within the flow. By virtue of the flow guiding device 7 being designed as a buoyancy member, the device 1 can be mounted immersed in a flow; by virtue of the horizontal design of the axis of rotation 6, the device 1 always orients itself optimally in the flow, such that no external adaptation measures are necessary. The device 1 itself is of essentially symmetric design, which is to say that the flow guiding device 7 has the same appearance from both incident flow directions. The support members 2 are also designed for reversing rotational operation.

FIG. 6 is a side view of the flow guiding device 7 with a wall as arm 8 and the support 18. A through opening 20 for the shaft (not shown) is formed within the arm 8. The symmetric design with respect to a plane passing vertically through the bore 20 for the shaft 16 is evident, as is the inclined configuration of the underside of the flow guiding device from the respective leading edge 17 to the center of the flow guiding device 7. The lowest point of the underside of the flow guiding device is then in the central plane and opposite the greatest radius of the support members 2.

FIG. 7 shows the flow guiding device 7 with no arms. The side walls are designed as approximately triangular profiles; support members are arranged within the flow guiding device in order to permit mechanical stiffening.

The support members are clad with a closed shell in order to form an inner cavity.

FIG. 8 is a perspective representation of the flow guiding device 7 with the arms 8 and the supports 18 located thereon; FIG. 9 is a schematic front view of FIG. 8, showing the yoke-like configuration of the flow guiding device in combination with the arms 8 and the supports 18 for mounting the shaft (not shown).

FIG. 10 is a plan view of the flow guiding device 7, showing that the supports 18 project beyond the side edges of the flow guiding device 7. The contour of the flow guiding device 7 extends beyond the entire width and thus beyond the interspace between the arms 8.

FIG. 11 shows, in isolation, a sleeve 50 for mounting on a shaft 16 (not shown). The sleeve 50 has, on its outer side, the stops 5 designed as dampers, which are arranged on a line parallel to the center line or central axis of the sleeve 50, along the longitudinal extent of the latter. The stops 5 may be designed as damper elements in the form of nylon stoppers, which are arranged on projections of star-like disks 51. The star-like disks 51 are provided with a central cutout and are connected to one another in series to form the sleeve 50. Flanges 52 are arranged at the ends in order to hold the sleeve 50 securely on the shaft 16.

FIG. 12 shows such a sleeve 50 mounted on the shaft 16 between the two support members 2. The sleeve 50 has an essentially cylindrical outer contour from which the stops 5 project. The support members 2 have both an outward-oriented curvature or angled face and one which is oriented toward the sleeve 50, such that the flow cross section reduces in the direction of the shaft 16. The inner sides, that is to say those sides of the support members 2 which are oriented toward the pressure surfaces (not shown), have a conical or domed profile in the direction of the shaft 16, such that a flow-guiding contour results. Thus, a reduction of the flow cross section between the two mutually opposite support members 2 will increase the flow speed in the region of the shaft 16.

A variant of the invention is shown in FIG. 13, in which the support members 2 have, on the inner side oriented toward the shaft 16, a straight-walled contour while the contour of the shaft 16—and thus also that of the stops 15—is barrel-shaped, that is to say curved away from the axis of rotation 6. This also narrows the flow cross section, which can lead to an increase in efficiency.

1. A device for utilizing kinetic energy of a flowing medium, comprising support members which are mounted on a shaft about an axis of rotation and are spaced apart axially from each other, pressure surfaces arranged between the support members and which are mounted on the support members so as to be able to pivot about an axis and that bear against stops which limit the pivoting movement, and , a flow guiding device spaced radially from the pressure surfaces which is structured as a buoyancy member and forms, together with the pressure surfaces, a contour that narrows a flow cross section between the pressure surfaces and the flow guiding device.

2. The device as claimed in claim 1, wherein the flow guiding device is curved in the direction of the axis of rotation.

3. The device as claimed in claim 1, wherein the flow guiding device extends above both support members.

4. The device as claimed in claim 1, wherein the flow guiding device is symmetric in cross section.

5. The device as claimed in claim 1, further comprising arms, on which the shaft is mounted, project from the flow guiding device.

6. The device as claimed in claim 5, wherein the arms are designed as walls.

7. The device as claimed in claim 6, wherein the arms are designed as buoyancy members.

8. The device as claimed in claim 1, wherein the stops are arranged on the shaft, distributed over the length of the latter.

9. The device as claimed in claim 1, wherein the stops are attached to the shaft on projecting supports.

10. The device as claimed in claim 1, wherein the stops have a damping device or are made of a damping material.

11. The device as claimed in claim 1, further comprising a generator is coupled to the shaft, either directly or via a transmission.

12. The device as claimed in claim 1, wherein the shaft, arms and/or support members have a curvature which is oriented toward the pressure surfaces.

13. The device as claimed in claim 5, wherein the shaft, the arms and/or the support members have a curvature which is oriented toward the pressure surfaces.
